(19) United States
(12) Patent Application Publication
(10) Pub. No.: US 2016/0050857 A1
(43) Pub. Date: Feb. 25, 2016

(54) PLANT POT SYSTEM

(71) Applicant: Tracy ROBERTS, Benicia, CA (US)

(72) Inventor: Tracy Roberts, Benicia, CA (US)

(21) Appl. No.: 14/778,992

(22) PCT Filed: Jul. 8, 2014
(86) PCT No.: PCT/US2014/045821

§ 371 Date: Sep. 21, 2015

Related U.S. Application Data
(60) Provisional application No. 61/843,458, filed on Jul. 8, 2013.

(51) Int. Cl. A01G 9/02; A01G 1/00

(52) U.S. Cl. CPC A01G 9/028; A01G 9/021; A01G 1/001

(57) ABSTRACT

Described is a plant pot system that can house plant growing media or soil designed for multistage growth of plants. The plant pot system includes a pot with a divider slot in the sidewall and a divider which is removably insertable into the divider slot of the pot. When the divider is inserted into the divider slot of the pot, the pot is divided into an upper section, which provides a smaller space for a young plant to establish healthy roots, and a lower section. Once the plant has reached an appropriate stage of development, the divider can be removed from the pot, allowing the plant to utilize the remaining growth media in the lower section for the next stages of growth and maturity. This eliminates the need for transplanting the plant into a different, larger container for next stages of growth.

This application claims priority to and the benefit of U.S. Provisional Patent Application No. 61/843,458, filed on Jul. 8, 2013, entitled “Multistage Plant Growth Pot,” the disclosure of which is hereby incorporated by reference in its entirety.

### BACKGROUND

For indoor gardening, it is common practice to take a rooted seedling, annuals in particular, and plant it into a smaller sized pot at first in order to develop a good root “ball.” A root ball is the main mass of roots at the base of a plant. Developing a good root ball will ensure a healthy root zone for a plant. It is of particular significance in horticulture when plants are repotted or planted out in the ground. The quality and preparation of the root ball will determine how well the plant will survive this transplantation and then flourish in its new situation. Once the plant has become “root bound” in a small container, it is customary to transplant the maturing plant into a larger container. Generally, most plants can grow about forty percent larger by doubling the plant pot size. The larger pot allows for further root and plant growth, which results in a greater fruit, vegetable, and/or flower production.

Plant transplants are an important part of keeping healthy plants and gardens. When a plant grows too big for its current container, its roots can be damaged or suffocated, which results in slowed growth and unhealthy appearances. To prevent such damage, the plant should be transferred from its smaller container to a larger container. While such transplants are important, the process can be dangerous and traumatic for the plants. In addition, the process is messy and time consuming, especially if there are a dozen or more potted plants to transplant.

Embodiments of the invention address these and other problems.

### SUMMARY

The present technology relates generally to a plant pot system that can house plant growing media or soil designed for multistage growth of plants. The plant pot system can separate the media/soil into sections by using a removable divider(s) for the purpose of root development in two or more stages of plant growth and maturity, eliminating the need for transplanting.

With a removable divider intact, the upper portion of the pot (which can be approximately one third of the volume of the entire pot) provides a smaller vegetative portion, which allows healthy development of a root ball for a plant. Once the root zone for the plant has developed, the divider can be removed from the plant pot system, exposing the remaining growing medium to the roots, allowing the second stage of growth. In embodiments of the present invention, the plant pot system is designed to durable and reusable.

According to one embodiment, a plant pot system is provided. The plant pot system can include a pot comprising a base having a periphery, and a sidewall extending uprightly from the periphery of the base forming an open top end and a cavity for the pot, wherein the sidewall comprises a divider slot that divides the pot into an upper section and a lower section. The plant pot system further includes a divider that is configured to be removably insertable into the divider slot.

According to another embodiment, a plant pot system further includes at least one upper drainage hole above the divider and at least one lower drainage hole at the base and/or sidewall of the pot.

According to yet another embodiment, a plant pot system includes a divider slot cap which can be used to plug the divider slot of the pot. The plant pot system can further include an upper drainage hole plug to plug the upper drainage hole when the divider is removed from the pot.

Another embodiment is directed to a method of using a plant pot system comprising a pot that comprises a base having a periphery, and a sidewall extending uprightly from the periphery of the base forming an open top end and a cavity for the pot, the sidewall comprising a divider slot that divides the pot into an upper section and a lower section. The plant pot system also comprises a divider that is configured to be removably insertable into the divider slot. The method includes filling the lower section with a second growth media, inserting the divider into the divider slot, filling the upper section with a first growth media and a plant, and withdrawing the divider from the divider slot after the plant reaches a predetermined time.

Numerous benefits are expected by way of the present technology over conventional ways of growing plants. For example, embodiments provide a plant pot system that eliminates the need for transplanting. A single plant pot system can be used for growing plants through multiple stages, thereby reducing any potential shock to the growing plant. In another example, the shelf life of plants in stores can be extended. Once a plant has become “root bound” in a smaller container, its health can deteriorate. By utilizing a removable divider, the space for the roots can be expanded, and the plant can continue to grow, thereby extending its shelf life time in the store. In yet another example, the plant pot system can also be biodegradable, and therefore, environmentally friendly.

These and other embodiments of the invention along with many of its features are described in more detail in conjunction with the text below and the attached figures.

### BRIEF DESCRIPTION OF THE DRAWINGS

FIGS. 1A through 1D illustrate vertical sectional views of components of a plant pot system according to an embodiment of the present invention.

FIG. 2 illustrates a top view of a pot and a divider half way inserted into the pot according to an embodiment of the present invention.

FIG. 3 illustrates a top view of a divider slot cap according to an embodiment of the present invention.

FIG. 4 illustrates a perspective view of a divider slot cap according to an embodiment of the present invention.

FIGS. 5A through 5E illustrate components of a plant pot system according to another embodiment of the present invention.

### DETAILED DESCRIPTION

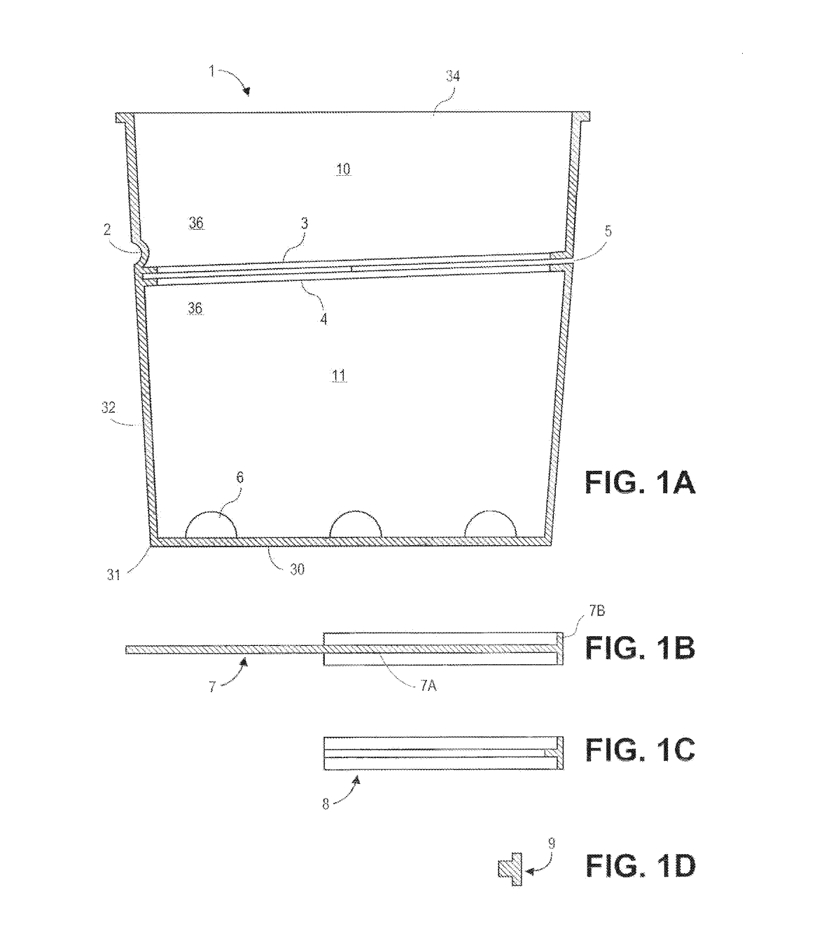

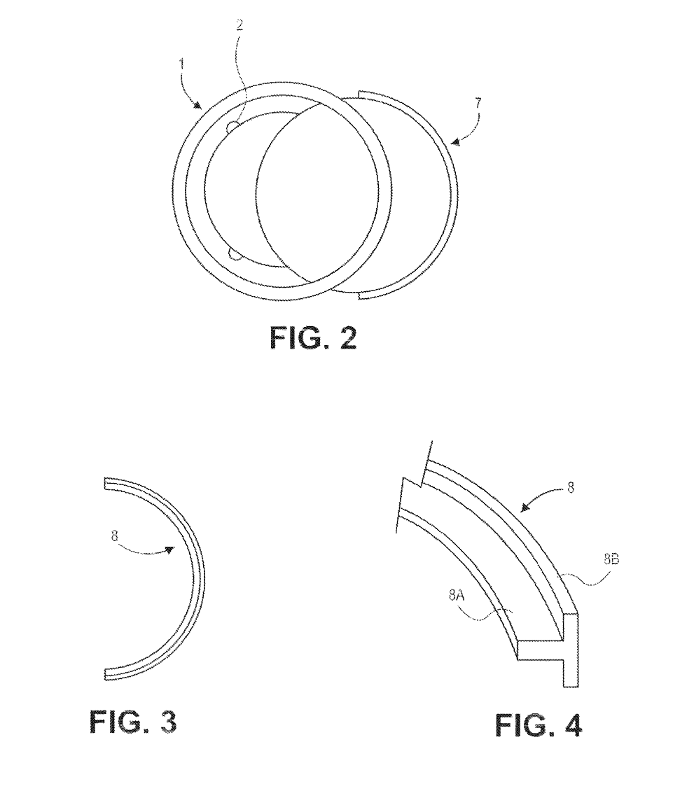

Embodiments of the present technology relate to a plant pot system. As shown in FIGS. 1A through 1D, in some embodiments, the plant pot system 100 can include at least two components—a pot 1 that holds soil or other plant growth media (shown in FIG. 1A), and a divider 7 (shown in FIG. 1B) which is removably insertable into the pot 1 through a horizontal divider slot 5 in the sidewall of the pot. In other embodiments, a divider slot cap 8 (shown in FIG. 1C) and/or an upper drainage hole 9 plug (shown in FIG. 1D) can also be included in the plant pot system 100 in addition to the pot 1 and the divider 7.

In one implementation, the plant pot system in accordance with embodiments described herein can be used as follows. The user can fill the pot 1 with plant media/soil to within about an inch or two from the top of the pot. When the user inserts the divider 7 into the divider slot 5 in the sidewall of the pot, the divider 7 is inserted between an upper flange 3 and a lower flange 4 of the pot. The space between the upper flange 3 and the lower flange 3 may define the slot. The insertion of the divider 7 into the divider slot 5 of the pot 1 creates the first root growth area, vegetative section (also referred to as an upper section) which can be considered a “small” pot. The user can then plant a seed/or seedling into the growth media contained within the vegetative section. In an embodiment, as the user waters the seedling during the first stage of growth, excess water can flow through an upper drainage hole 2, which may be located on the opposite side of the divider slot in the upper section of the sidewall as shown in FIG. 1A. In an embodiment, the divider slot 5 may be sloped downward towards the upper drainage hole 2, allowing excess water to flow along the sloped divider. The upper drainage hole 6 can also act as a viewing hole for root development. Once roots are visible through the upper drainage hole 6, it would be safe to assume that the divider 7 can be removed. The user can then begin the “transplanting” process by simply removing the divider 7 to expose the plant roots to the rest of the growth media in the pot.

Once the divider 7 is removed, the user can insert the divider slot cap 8 into the divider slot 5 and plug the upper drainage hole 2 with the drain plug 9. The user can then gently press and compact the soil to remove any gap between the roots/media in the vegetative section 10 and the flowing growth section 11 (also referred to as a lower section) located below the divider slot. As the user waters the maturing plant during the final stage of growth, excess water can flow through lower drainage holes 6 at the bottom of the pot 1.

Referring to FIG. 1A, the pot 1 can be in any suitable shape and size. As shown in FIG. 1A, the pot 1 can be generally cylindrical in shape and includes a base 30 that has a periphery 31 and a sidewall 32. The sidewall 32 extends upwardly from the periphery 31 of the base 30, forming an open top end 34 and a cavity 36 for the pot 1. While the pot 1 shown in FIG. 1A is generally cylindrical, the pot can be in any suitable shape. For example, the pot can be in the shape of a cube, a rectangular prism, a sphere, or the like. In an embodiment, the pot can be tapered towards the base as shown in FIG. A for stackability. The pot 1 can also be manufactured in any suitable size (e.g., 1 liter, 10 liters, 2 gallons, or the like).

FIG. 2 illustrates a top plan view that shows the divider 7 half way inserted into the divider slot 5 of the pot 1. The divider slot 5 is located substantially horizontally in the middle portion of the sidewall 32 and divides the pot 1 into an upper section 10 and a lower section 11 as shown in FIG. 1A. In an embodiment, the pot 1 can have flanges that are curved and extend inwardly from the sidewall into the cavity to assist the divider 7 from sliding in and out of the divider slot 5 of the pot. For example, the pot 1 can have an upper flange 3 (which is curved and extends inwardly into the interior of the pot above the divider slot) and/or a lower flange 4, (which is curved and extends inwardly into the interior of the pot below the divider slot 5). The upper and lower flanges may extend inwardly and may have the same general shape as the sidewall of the pot. For example, if the sidewall is a cylindrical sidewall, then the upper and lower flanges may be in the form of rings. In another example, the upper and lower flanges can be in the form of discontinuous tabs inside the sidewall. When the user inserts the divider 7 into the divider slot 5 of the pot, the upper flange 3 and the lower flange 4 can assist the divider 7 slide into the divider slot 5. The upper and lower flanges can also provide structural support for the divider 7. When completely inserted into the divider slot 5, the divider 7 creates a cavity in the upper section 10 (the first root growth area) and a cavity in the lower section 11 below the divider 7 (the next stage growth area).

In embodiments of the present technology, the divider slot 5 can be located in a middle portion of the sidewall 32 of the pot 1. Generally, the divider slot 5 is positioned such that when the divider 7 is inserted into the pot 1, the volume of the upper section 10 created by the divider partitioning is less than the volume of the lower section 11. Such partitioning creates a “small” pot area in the upper section 10 which allows the first root growth. In general, it is easier for a seed to germinate in a small pot. In one embodiment, the volume ratio of the upper section 10 and the lower section 11 is about 1 to 2, or less. Once the root zone has developed, the divider 7 can be removed, exposing the remaining growing medium to the roots, allowing for the next stage of growth.

The divider slot 5 can extend any suitable length along the sidewall so that the divider 7 can be fully inserted into and removed from the pot. For example, the divider slot 5 can extend about one half of the circumference of the middle portion of the pot 1, forming a generally horizontal half circle around the sidewall 32 of the pot 1. If the pot is cubic or another shape, then the divider slot can be shorter, for example, about 25 percent of the circumference of the cubic sidewall. The width of the divider slot 5 can be selected such that it allows an easy insertion and removal of the divider 7, but does not affect the physical strength and integrity of the pot 1. In an embodiment, the width of the divider slot 5 can be generally about the same as the thickness of the divider 7. For example, the width of the divider slot can be between about 0.1 millimeters to 10 millimeters, or between about 1 millimeter and 5 millimeters for smaller pots. When a small width (e.g., 5 millimeters or less) is selected for the divider slot, it can minimize soil or growth media from spilling through the divider slot even when the divider 7 or the divider slot cap 8 is not inserted in the divider slot 5 of the pot.

In one embodiment, the divider slot 5 can be generally parallel to the base 30 of the pot. In another embodiment, the divider slot 5 is sloped such that when the divider 7 is inserted into the divider slot 5, it slopes downward towards the upper drainage hole 2 on the sidewall. For example, the divider slot 5 can be sloped at an angle of about from 5 to 30 degrees in relation to the base. The sloped divider slot 5 and the divider 7 can assist excess water to flow down the divider and drain through the upper drainage hole 2.

The pot 1 can have a plurality of holes that assist in drainage of excess water. The sidewall 32 of the pot has at least one upper drainage hole 2, which is located above the upper flange 3 and the divider slot 5. The upper drainage hole 2 allows excess water to drain when watering a plant in the upper section 10 of the pot 1. While the cross sectional view shown in FIG. 1A illustrates a single upper drainage hole, the sidewall 32 can include multiple upper drainage holes. In one embodiment, the upper drainage holes can be located on one side of the sidewall (e.g., on the opposite side of the divider slot) so that excess water can drain down along the sloped divider towards the upper drainage holes. In another embodiment, the upper drainage holes can be distributed along the sidewall at the same height.

The lower section 11 of the pot 1 can also have at least one drainage hole 6 to drain excess water when the divider 7 is removed from the pot. In the embodiment shown in FIG. 1A, each of the lower drainage holes 6 is located at the corner of where the base 30 meets with the sidewall 32. Such lower drainage holes also allow the user to visualize plant roots venturing out from the lower drainage holes without lifting the pot. When the roots start venturing out from the lower drainage holes, the user can either transplant the entire pot or the plant itself into the ground for the next stages of growth.

FIG. 1B illustrates the divider 7 according to one embodiment. The divider 7 includes a divider plate 7A and a divider rim 7B. As shown in FIG. 2, the divider plate 7A of the divider 7, when inserted into the divider slot 5 of the pot 1, expands across the cross section of the pot and divides the pot into two sections. As shown in FIG. 1B, the divider rim 7B may have a width that is thicker than the divider plate 7A, providing a grip for the user's hand. The divider rim 7B contacts and rests on the outside of the sidewall. The divider 7 may be impermeable or substantially impermeable to the roots of the plant that is growing in the pot 1 and/or water.

FIG. 1C illustrates a divider slot cap 8 according to one embodiment.

The divider slot cap 8 can be used to block the divider slot 5 of the pot when the divider 7 is removed from the pot 1. FIG. 3 illustrates a top view of the divider slot cap 8. FIG. 4 illustrates a perspective view of the divider slot cap 8. As shown in FIG. 4, the divider slot cap 8 has a cap insert 8A which is inserted into the divider slot 5 and a cap rim 8B which contacts and rests on the outside of the sidewall 32 when the divider slot cap 8 when it is fully inserted into the divider slot 5 of the pot. The divider slot cap 8 can prevent or reduce growth media from spilling through the divider slot 5 of the pot 1.

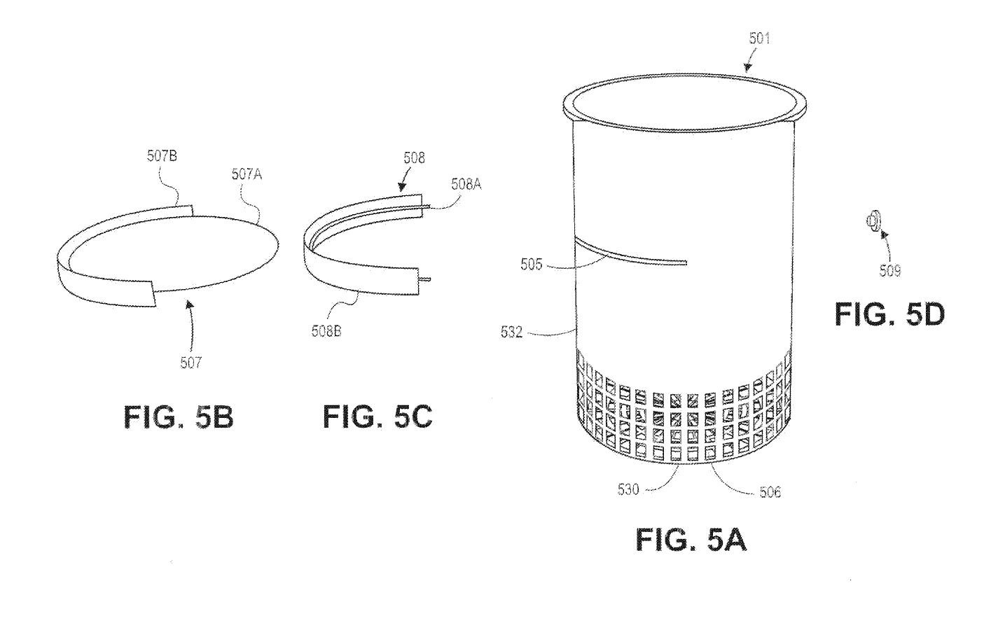

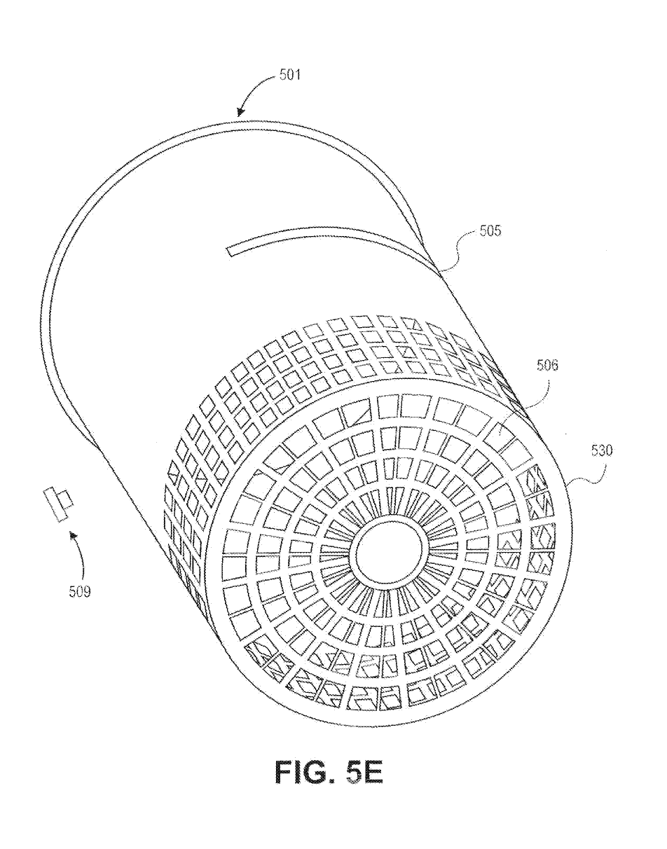

FIGS. 5A through 5E illustrate a plant pot system 500 in accordance with another embodiment. FIG. 5A shows a plant pot 501 with a base 530 and a sidewall 532 with mesh openings 506 at the base and a bottom portion of the sidewall 532 adjacent to the base. FIG. 5E illustrates a bottom perspective view of the plant pot 501 shown in FIG. 5A. The mesh openings 506 assist excess water to drain through the pot. As shown in FIG. 5A, the pot 501 is cylindrical in shape, and has a divider slot 505 which circles a half way around the circumference of the sidewall 532 in the middle portion of the pot. The pot 501 also has at least one upper drainage hole (not shown in FIG. 5A). In an embodiment, the upper drainage hole(s) are located on the sidewall on the opposite side of the divider slot 505. FIG. 5D illustrates an upper drainage hole plug 509, which can be used to plug the upper drainage hole when a divider is removed and the entire pot is used to grow a plant.

FIG. 5B illustrates a divider 507 according to another embodiment.

The divider 507 has a divider plate 507A and a divider rim 507B coupled to the edges of the divider plate 507A. When the divider 507 is inserted into the divider slot 505, the divider plate 507A divides the pot 501 into an upper section and a lower section. The divider rim 507B rests along the sidewall 532 of the pot when the divider 507 is fully inserted into the pot 501.

FIG. 5C illustrates a divider slot cap 508 according to another embodiment.

The divider slot cap 508 has a cap insert 508A which inserts into the divider slot 505 and a cap rim 508B which rests on top of the sidewall 532 when the divider slot cap 508 is inserted into the divider slot 505. In an embodiment, the divider slot cap 508 can be inserted into the divider slot 505 when the divider 507 is removed from the pot. In another embodiment, the plant pot system 500 can be used without the divider slot cap 508 if the width of divider slot 505 is small enough to prevent soil or growth media from spilling through the divider slot 505.

In one embodiment, the pot 501 shown in FIG. 5A does not have upper or lower flanges to assist the divider 507 in place inside the pot. Instead, the divider 507 can be supported by the weight of growth media placed in the lower section of the pot underneath the divider. In an embodiment, the user can fill the pot with growth media up to the level of the divider slot 505 or a fill line marked inside the pot near the divider slot. Then the user can insert the divider 507 into the divider slot 505. The upper section of the pot can then be filled with additional growth media, and the divider 507 can be settled at a desired location by the weight of the growth media.

Any suitable materials can be used to make components of a plant pot system. For example, any plastic materials, such as polypropylene or polystyrene, may be used as long as they are durable and reusable. All of the components of the plant pot system can be made from the same material or from different materials. In one embodiment, at least the pot of the plant pot system is made from biodegradable materials, such as peat pots. Using biodegradable pots, the pots can be directly buried underground after removal of the divider during the appropriate plant growth stage. This can further reduce any potential shock to the roots of the plant.

The plant pot system can be packaged in various ways. In one embodiment, all of the components—a pot, a divider, a divider slot cap, and at least one upper drainage hole plug—can be packaged together as a bundle to be sold together. In another embodiment, the pot can be pre-filled with growth media appropriate for certain plants. In some embodiments, seeds for certain plants may be pre-deposited in the growth media. In yet another embodiment, the pot can be pre-filled with two different growth media—first growth media appropriate for developing root balls in the upper section above a divider in the pot and second growth media in the lower section of the pot appropriate for the next growth stage.

Another embodiment is directed to a method of using a plant pot system comprising a pot comprising a base having a periphery, and a sidewall extending uprightly from the periphery of the base forming an open top end and a cavity for the pot, the sidewall comprising a divider slot that divides the pot into an upper section and a lower section. The system also includes a divider that is configured to be removably insertable into the divider slot. The method includes filling the lower section with a second growth media (e.g., soil and plant food). Once the lower section is filled with growth media, the divider is inserted into the divider slot. The upper section is filled with a first growth media (e.g., soil and plant food for a seedling) and a plant (e.g., a seedling). In an embodiment, the first growth media and the second growth media are the same. In this embodiment, if desired, the entire pot can be filled with the growth media prior to insertion of a divider. In another embodiment, the first growth media and the second growth media are different, and each growth media is adjusted for different stages of plant growth. The growth media can include, for example, dirt, potting mixes, coir, peat moss, sphagnum moss, bark vermiculite, perlite, hydroton, rice hulls, sand, osmunda fiber, pumice, clay aggregate, diatomite, hardwood, charcoal, or the like. After a predetermined time (e.g., when the roots of the plant are visible through upper drainage holes in the pot or when the roots otherwise contact or “ball up” against the divider), the divider can be withdrawn from the divider slot.

At this point, the roots are free to grow downward into the lower section of the pot which contains the second growth media. Once the plant reaches maturity or the roots are visible from the lower drainage holes or mesh openings, the plant can be removed from the pot and can be planted elsewhere. In some embodiments, the pot and the plant can be buried underground for the next stages of growth.

Other embodiments of the invention are also possible. For example, although the above described systems include a single divider, other embodiments of the invention may include multiple dividers (e.g., 2, 3, 4, etc.). For example, a plant pot system may include a pot with three divider slots with three corresponding dividers. The dividers may be substantially parallel to each other when they are inserted into their respective divider slots.

The types of plants that can be used with the plant pot system are not limited. These include annuals, especially those which produce fruit, vegetables, herbs, and flowers. Examples of such plants may include tomatoes, beans, broccoli, cucumber, salad greens, onions, cannabis, orchids, other flowers, herbs, or the like.

Embodiments of the invention have a number of features of interest. For example, using embodiments of the invention, a plant does not need “re-potted” after it reaches a size where it has outgrown its current pot. This results in substantial labor savings and reduces the shock to the plant, thereby increasing the chances that the plant will remain healthy. Further, embodiments of the invention reduce the number of pots that need to be retained by users. For instance, by using a divider, only one pot is used, instead of multiple pots. This saves on space and expense. This can be especially useful for plants that may be sold in stores. In some cases, plants that are sold in stores may remain in inventory for some time. If a plant needs to be re-potted because it has outgrown its current pot while waiting to be sold, then the plant needs to be re-potted. This again is laborious, time-consuming and expensive. Embodiments of the invention can be used for plants in a store that are waiting to be sold. Instead of repotting plants, as explained above, a divider in a plant pot system can simply be removed while the plants are on a shelf waiting to be sold. This improves the life of the plant and also reduces the risk of damaging the plants that are to be sold.

One or more features from any embodiment may be combined with one or more features of any other embodiment without departing from the scope of the invention.

A recitation of “a,” “an,” or “the” is intended to mean “one or more” unless specifically indicated to the contrary.

It is also understood that the examples and embodiments described herein are for illustrative purposes only and that various modifications or changes in light thereof will be suggested to persons skilled in the art and are to be included within the spirit and purview of this application and scope of the appended claims.

All elements, parts and steps described herein are preferably included. It is to be understood that any of these elements, parts and steps may be replaced by other elements, parts and steps or deleted altogether as will be obvious to those skilled in the art.

Broadly, this description presents a multistage plant growth pot.

In short summary, described herein a plant pot system that can house plant growing media or soil designed for multistage growth of plants. The plant pot system includes a pot with a divider slot in the sidewall and a divider which is removably insertable into the divider slot of the pot. When the divider is inserted into the divider slot of the pot, the pot is divided into an upper section, which provides a smaller space for a young plant to establish healthy roots, and a lower section. Once the plant has reached an appropriate stage of development, the divider can be removed from the pot, allowing the plant to utilize the remaining growth media in the lower section for the next stages of growth and maturity. This eliminates the need for transplanting the plant into a different, larger container for next stages of growth.

Concepts

This writing discloses at least the following concepts.
Concept 1. A plant pot 1 system comprising:
   a pot comprising:
      a base; and
      a sidewall extending from the base forming a cavity for the pot, the sidewall having a divider slot that divides the pot into a first section and a second section; and
      a divider that is configured to be removably insertable into the divider slot.
Concept 2. The plant pot system of Concept 1 wherein the sidewall is cylindrically shaped, and the divider slot is substantially parallel to the base of the container.
Concept 3. The plant pot system of Concept 1 or 2 wherein the divider slot is sloped at an angle compared to the base of the pot.
Concept 4. The plant pot system of any one of the preceding concepts wherein a volume ratio of the upper section to the lower section of the pot, which, when inserted with the divider, is about 1 to 2.
Concept 5. The plant pot system of any one of the preceding concepts wherein the sidewall has at least one upper drainage hole in the upper section of the pot on an opposite side of the divider slot.
Concept 6. The plant pot system of Concept 5, further comprising at least one upper drainage hole plug which is configured to plug the upper drainage hole.
Concept 7. The plant pot system of Concept 6 wherein the divider slot is sloped compared to the base so that when the divider is inserted into the divider slot, the divider is sloped downwards towards the at least one upper drainage hole to promote water flow towards the at least one upper drainage hole.
Concept 8. The plant pot system of any one of the preceding concepts wherein the pot comprises at least one lower drainage hole at a corner of the base and a bottom portion of the sidewall adjacent to the base.
Concept 9. The plant pot system of any one of concepts 1-5 wherein the base and a portion of the sidewall adjacent to the base are formed of a mesh with a plurality of openings.
Concept 10. The plant pot system of any one of the preceding concepts, further comprising 1 a divider slot cap which is configured to plug the divider slot of the pot when the divider is removed from the pot.
Concept 11. The plant pot system of any one of the preceding concepts wherein the upper section of the pot has an upper flange extending inwardly from the sidewall above the divider slot and wherein the lower section of the pot has a lower flange extending inwardly from the sidewall below the divider slot.
Concept 12. The plant pot system of any one of the preceding concepts wherein the sidewall of the pot further comprises at least one additional divider slot, and the plant pot system further comprising at least one additional divider that is configured to be removably insertable into the at least one additional divider slot.
Concept 13. The plant pot system of any one of the preceding concepts wherein the pot is biodegradable.
Concept 14. The plant pot system of any one of the preceding concepts wherein the upper section of the pot is filled with a first growth media and the lower section of the pot is filled with a second growth media, which has a different nutritional content than the first growth media.
Concept 15. A method of using a plant pot system comprising a pot comprising a base having a periphery, and a sidewall extending uprightly from the periphery of the base forming an open top end and a cavity for the pot, the sidewall comprising a divider slot that divides the pot into an upper section and a lower section; and a divider that is configured to be removably insertable into the divider slot comprising:
   filling the lower section with a second growth media;
   inserting the divider into the divider slot;
   filling the upper section with a first growth media and a plant; and
   withdrawing the divider from the divider slot after the plant reaches a predetermined time.
Concept 16. The method of Concept 15 wherein the pot has an upper drainage hole in the upper section and wherein the predetermined time is when roots of the plant are visible through the upper drainage hole.
Concept 17. The method of Concept 15 or 16 wherein the first growth media 1 and the second growth media have different nutritional content.
Concept 18. The method of Concepts 15, 16, or 17 further comprising removing the plant from the pot after a second predetermined time.
Concept 19. The method of Concepts 15, 16, 17, or 18 wherein the sidewall is cylindrical and the base is flat and circular.
Concept 20. The method of any one of Concepts 15-19 wherein the base and a portion of the sidewall adjacent to the base are formed of a mesh having a plurality of openings.

What is claimed is:

1. A plant pot system comprising:
a pot comprising:
a base; and
a sidewall extending from the base forming a cavity for the pot, the sidewall having a divider slot that divides the pot into a first section and a second section; and
a divider that is configured to be removably insertable into the divider slot.

2. The plant pot system of claim 1 wherein the sidewall is cylindrically shaped, and the divider slot is substantially parallel to the base of the container.

3. The plant pot system of claim 1 wherein the divider slot is sloped at an angle compared to the base of the pot.

4. The plant pot system of claim 1 wherein a volume ratio of the upper section to the lower section of the pot, which, when inserted with the divider, is about 1 to 2.

5. The plant pot system of claim 1 wherein the sidewall has at least one upper drainage hole in the upper section of the pot on an opposite side of the divider slot.

6. The plant pot system of claim 5, further comprising at least one upper drainage hole plug which is configured to plug the upper drainage hole.

7. The plant pot system of claim 6 wherein the divider slot is sloped compared to the base so that when the divider is inserted into the divider slot, the divider is sloped downwards towards the at least one upper drainage hole to promote water flow towards the at least one upper drainage hole.

8. The plant pot system of claim 1 wherein the pot comprises at least one lower drainage hole at a corner of the base and a bottom portion of the sidewall adjacent to the base.

9. The plant pot system of claim 1 wherein the base and a portion of the sidewall adjacent to the base are formed of a mesh with a plurality of openings.

10. The plant pot system of claim 1, further comprising a divider slot cap which is configured to plug the divider slot of the pot when the divider is removed from the pot.

11. The plant pot system of claim 1 wherein the upper section of the pot has an upper flange extending inwardly from the sidewall above the divider slot and wherein the lower section of the pot has a lower flange extending inwardly from the sidewall below the divider slot.

12. The plant pot system of claim 1 wherein the sidewall of the pot further comprises at least one additional divider slot, and the plant pot system further comprising at least one additional divider that is configured to be removably insertable into the at least one additional divider slot.

13. The plant pot system of claim 1 wherein the pot is biodegradable.

14. The plant pot system of claim 1 wherein the upper section of the pot is filled with a first growth media and the lower section of the pot is filled with a second growth media, which has a different nutritional content than the first growth media.

15. A method of using a plant pot system comprising a pot comprising a base having a periphery, and a sidewall extending uprightly from the periphery of the base forming an open top end and a cavity for the pot, the sidewall comprising a divider slot that divides the pot into an upper section and a lower section; and a divider that is configured to be removably insertable into the divider slot comprising:
filling the lower section with a second growth media;
inserting the divider into the divider slot;
filling the upper section with a first growth media and a plant; and
withdrawing the divider from the divider slot after the plant reaches a predetermined time.

16. The method of claim 15 wherein the pot has an upper drainage hole in the upper section and wherein the predetermined time is when roots of the plant are visible through the upper drainage hole.

17. The method of claim 15 wherein the first growth media and the second growth media have different nutritional content.

18. The method of claim 15 further comprising removing the plant from the pot after a second predetermined time.

19. The method of claim 15 wherein the sidewall is cylindrical and the base is flat and circular.

20. The method of claim 15 wherein the base and a portion of the sidewall adjacent to the base are formed of a mesh having a plurality of openings.
